(19) United States
(12) Patent Application Publication
(10) Pub. No.: US 2026/0330568 A1
(43) Pub. Date: Oct. 22, 2026

(54) REPAIR ESTIMATE QUALITY ASSURANCE AUTOMATION

(71) Applicant: ACCURENCE, INC., Louisville, CO (US)

(72) Inventors: Zachary Labrie, Broomfield, CO (US); Jacob Labrie, Broomfield, CO (US); Timothy Bruffey, Commerce City, CO (US)

(21) Appl. No.: 19/183,441

(22) Filed: Apr. 18, 2025

(51) Int. Cl. G06Q 40/08

(52) U.S. Cl. CPC G06Q 40/09; G06Q 40/0841

(57) ABSTRACT

A system and method for automated quality assurance review is described, wherein a document, preferably an estimate, is received by the automated quality assurance review system and subsequently analyzed by a processor executing instructions stored in a computer readable memory to determine whether the estimate meets applicable quality control parameters.

### CROSS-REFERENCE TO RELATED APPLICATIONS

This application claims priority to and the benefit of U.S. patent application Ser. No. 15/606,475, filed on May 26, 2017, which claims priority to and the benefit of U.S. Provisional Patent Application No. 62/341,873, entitled “Repair Estimate Quality Assurance Automation,” which was filed on May 26, 2016 and is hereby incorporated by reference herein in its entirety and for all purposes.

### FIELD

The present disclosure relates to estimates for repairing, replacing, or otherwise compensating for damaged properties or other losses, and more particularly to systems and methods for automated quality assurance of such estimates.

### BACKGROUND

When an insured property has potentially been damaged by a peril, one or multiple property inspections may be performed by, for example, an insurance adjuster, contractor, or third party vendor (“inspectors”) to see if peril-related damage has occurred. The inspectors take photographs and write up their findings. Some policyholders may have a contractor perform an inspection prior to deciding whether to file an insurance claim. If peril-related damages are found, inspectors often determine the necessary steps to repair the damage and write one or more estimates for those repairs. Each damage claim scenario is unique, so a great amount of detail and knowledge are required to perform a thorough inspection and write an accurate estimate.

Performing a thorough inspection for a claim is the foundation for being able to write an accurate estimate. During the inspection, the area of the property that may have been damaged is inspected for damaged and non-damaged items. Photos and measurements are taken as necessary or required. Consistency in performing thorough inspections is difficult because each inspection scenario is very unique. Properties in the same neighborhood may be impacted differently by a given peril due to the properties' construction attributes (e.g. type of construction, quality of construction, material types, age of materials), location attributes (e.g. tree coverage, direction the property faces), and peril attributes (e.g. direction of the storm, intensity of the storm, duration of the storm, temperature). Additionally, it is not uncommon for different inspectors to inspect the same property and identify different sets of damages. This is due to each inspector having a different level of inspector attributes (e.g. training, peril type experience, construction type experience, material type experience, inspection methodology, attention to detail). The inspector has a complex task at hand which can be made even more difficult by distractions that may be present at the property (e.g. policyholders, other inspectors, dogs), meteorological conditions (e.g. temperature, rain, daylight or lack thereof), and other demands (e.g. a large or particularly complex or difficult inspection, a heavy workload). Even the most experienced inspectors are challenged to consistently perform thorough inspections.

Before preparing an estimate, an inspector typically determines the scope of repair by evaluating, for example, which specific damages were caused by the peril and what actions and materials are necessary to repair the damages. An inspector may determine the scope of repair upon finding damaged items throughout the inspection process, or the inspector may determine the scope of repair after the inspection is complete, by reviewing all damaged items together. Like the inspection, determining the scope of repair is complex. During the inspection, the inspector typically finds both damaged and non-damaged items. The inspector has to determine what to do with the inspection findings.

Inspectors face many challenges when evaluating the scope of repair. One such challenge is that the inspector must decide whether each damaged item was damaged by the claimed peril. This is usually determined based upon the inspector's training and past experiences of seeing the item (or other items of a similar or identical material type) that were damaged by the same or similar peril or a peril of the same type. Sometimes, determining if damaged items were damaged by the claimed peril is a questionable, not straight forward proposition. Damaged items may have been damaged, for example, due to natural aging, wear and tear, manufacturer defects, previous perils, improper item installation, homeowner activities (lawnmower kicks up a rock, kids kicking a ball against the house), or fraudulent activity. Often, when damaged items are determined to not be peril related, the inspector uses non-damaged items as supporting evidence. For example, when one crack is found a few feet up on siding on one side of a house, but the large soft metal dryer vent on that same side of the house has no dings on it, the likelihood that the crack in the siding was caused by hail (one type of peril) is very low.

When an inspector is inspecting an insured property, the policyholder's insurance policy may have exclusions. Thus, particularly when the inspector is an adjuster responsible for interpreting the policy, as is often the case, the inspector may be responsible for reviewing the policy to determine which damaged items are covered by the policy for repair.

Another challenge when evaluating the scope of repair is that the inspector must usually choose a repair method for each item that was damaged (or at least believed by the inspector to have been damaged) by the peril. Particularly when the inspector is also an insurance adjustor, the inspector may choose a repair method only for those damaged items that are covered by the insurance policy. There are often multiple ways to repair a damaged item. In some cases, for example, it is possible that the damaged item can be repaired without affecting surrounding items. However, damaged items may be installed on top of, underneath, or integrated into other items that may or may not also be damaged. Often, then, a surrounding item will need to be manipulated or replaced during the process of repairing a damaged item.

Local building codes present another challenge for inspectors. There are tens of thousands of local municipalities throughout the United States. These municipalities usually adopt a version of the International Residential Code (“IRC”). The IRC is a set of building code regulations used by municipalities to help control the quality of building workmanship within the municipality. After adopting a version of the IRC, it is common for municipalities to amend the IRC for their local area. For example, a northern municipality may amend its IRC to increase the amount of ice and water shield necessary to prevent ice damming. Thus, inspectors often must learn the local building codes for the area in which they are working to ensure that they prepare a scope of repair that meets local building code.

Still another challenge for inspectors is that many companies have created guidelines for inspectors to follow to help them create more accurate scopes of repair. Depending on the company, the guidelines may be set forth in a simple one-or two-page document, or the guidelines may be so voluminous as to require a more complex document spanning dozens or even hundreds of pages, or the guidelines may fall somewhere in between these extremes. An inspector must memorize the guidelines or take the time to check them every time the inspector writes a scope of repair. Often these guidelines have some ambiguity, but even when clearly written, guidelines can be interpreted differently depending on how (or by whom) they are read. Additionally, guidelines are often continuously updated. As a result, each inspector may have a unique interpretation of a given company's guidelines, depending on how the inspector reads the guidelines and how the inspector keeps up with revisions to the guidelines.

A further challenge faced by inspectors in evaluating the scope of repair relates to the age of the damaged property. Properties may be almost new or they may be tens or hundreds of years old. There are times when a damaged item is no longer available for purchase. Thus, the inspector must know what items and material are and are not available, and must be able to identify acceptable substitutes for damaged items that cannot be repaired. Inspectors must therefore draw on training, industry bulletins, company guidelines, past experience, and/or other resources to know what items and materials are not available and to identify acceptable substitutes.

Once the damaged items are identified and/or catalogued for repair (e.g. once the scope of repair has been determined), the inspector must decide on the quantities of the repair items. This often requires the inspector to measure, count, or calculate the needed quantity of each repair item. Some item quantities may need to include a certain amount of waste that will be generated during the installation process, while other items do not. An inspector must know which item quantities to increase for waste, how much waste there will be, and take the time to calculate any needed quantity adjustments to ensure that an estimate accounts for the needed amount of material.

With a completed scope of repair and a list of needed repair materials, the inspector can generate an estimate. Pricing, depreciation, overhead, profit, and taxes may be applied to the scope of repair to create an estimate. The inspector may create the estimate by hand on a piece of paper, in a spreadsheet, or in an estimating system which has a standardized set of items, actions, and pricing. Estimating systems can allow freeform entry or selection from tens of thousands of items, so it can be cumbersome to memorize or look up the items that are needed for the estimate. Particularly if the estimate writer is an adjuster responsible for interpreting policy, the estimate writer can review the policy to determine if depreciation should be applied to each estimate line item and if so, how to apply the depreciation.

Because the inspection and estimate processes are unique and complex, it is typical for inspection companies and companies who receive the inspections to implement internal quality assurance (“QA”) processes to review and check the quality of the inspector's findings, including accompanying notes, sketches, photographs, measurements, and estimate. QA processes may or may not be performed on a claim, can occur at different points in the claim process workflow, and may be performed by an on-site field worker at the property or an off-site desk worker. The work of a QA person who is manually performing QA review is subject to all the same quality concerns as the inspector. Often QA reviewers limit their review to a short checklist of commonly found issues created by their company or based on their experience. Manual QA processes cannot be consistently relied upon to accurately or thoroughly assess an inspector's work product.

In a typical QA process, the QA reviewer looks over the inspector's photos, notes, and estimate, as well as the policy. The QA reviewer attempts to determine the logical steps (often undocumented) that the inspector made based on the inspection findings to arrive at the scope of damage, and based on the scope of damage to arrive at the estimate. This is often extremely difficult to do because the inspector's interpretations, thought processes, judgment calls, and calculations are not always transparent to the QA reviewer. Like the inspector, the QA reviewer also must reference and interpret company guidelines, policy coverage, local building codes, appropriate repair methods, structural diagrams, waste calculations, etc. This can be an overwhelming task, and even the best QA reviewers often do not have enough information, time, expertise, or capacity to accurately and fully assure the quality of an estimate. This is why most QA reviewers work off of a checklist of items that can be easily determined. For example, a QA reviewer may determine whether all required tasks were completed (e.g. whether all required inspection photos were taken, whether documentation supporting local labor rates was gathered, whether documentation supporting each material cost estimate has been provided, and so forth). Additionally or alternatively, the QA reviewer may utilize a short list of hot button items and/or common mistakes (e.g. whether the proper waste percentage was used for an item, whether adjacent items were compared for similar damage, and so forth).

Once repairs are commenced, it is not uncommon for an estimate to be found incomplete due to overlooked damage, incorrectly measured items, miscalculations, or unforeseen repair items. Either during the construction process or after the repair is completed, a contractor may send a request to an insurance carrier (e.g. for insured repairs) or property owner (e.g. for uninsured repairs) asking that additional items or quantities of items be added to the estimate. The industry calls these requests “supplements.” Supplements are sometimes necessary and sometimes not. For example, as damaged items are being removed from a property, additional damaged items may be discovered underneath an item, or the removal of a damaged item may cause unavoidable damage to a surrounding item. In these cases the supplement is often reviewed by the homeowner or insurance carrier and approved for payment to the contractor. However, when a contractor requests reimbursement for a large quantity of additional material without providing enough supporting documentation, the supplement may not be approved or paid. The QA reviewer typically makes a best effort to review all available information about the supplement claim to make the best possible decision, but as with the QA reviewer of the original estimate, the supplement QA reviewer may not have enough information, time, expertise, or capacity to accurately evaluate the justification for a supplement request.

These and other problems exist in the art of reviewing and checking the accuracy of property inspections and damage estimates, which have not been resolved. Thus, there is and has been a long-felt need for an improved and/or automated quality assurance review process.

### SUMMARY

An automated estimate quality assurance review system according to one embodiment of the present disclosure comprises a processor; a network interface; and a memory in which an estimate intake module, an estimate analysis module, and a messaging module are stored. The estimate intake module comprises instructions that, when executed, cause the processor to store an estimate received via the network interface in the memory, the estimate corresponding to a loss type and comprising loss data and estimate amount data. The estimate analysis module estimate analysis module comprises instructions that, when executed, cause the processor to make a determination, based on the received estimate and at least one piece of information not included in the received estimate, as to whether the received estimate meets a predetermined requirement. The messaging module comprises instructions that, when executed, cause the processor to generate a report containing the determination.

The automated estimate quality assurance review system may further comprise a data extraction module stored in the memory. The data extraction module comprises instructions that, when executed, cause the processor to identify at least one line item and at least one attribute of the at least one line item in the received estimate; and assign a probability score to the at least one line item, the probability score reflecting a probability of the at least one line item corresponding to the loss type. The determination may be based at least in part on the probability score.

The automated estimate quality assurance review system may further comprise a guideline engine stored in the memory. The guideline engine may comprise instructions that, when executed, cause the processor to derive a plurality of guidelines from the received estimate.

The automated estimate quality assurance review system may further comprise an estimate generation module stored in the memory. The estimate generation module may comprise instructions that, when executed, cause the processor to generate a new estimate by populating at least one form with data from the received estimate and by applying a predetermined set of guidelines. The estimate generation module may further comprise instructions that, when executed, cause the processor to compare at least a portion of the new estimate with at least a portion of the received estimate. The determination may be based at least in part on the comparison.

The estimate intake module may further comprise instructions that, when executed, cause the processor to query at least one of a subscriber database and a user database and to determine, based on a response to the query, whether to accept the received estimate for automated quality assurance review. The estimate intake module may further comprise instructions that, when executed, cause the processor to determine whether the received estimate meets a minimum data threshold. The automated estimate quality assurance review system may further comprise an importation module stored in the memory, the importation module comprising instructions that, when executed, cause the processor to convert the received estimate from a first file format into a second file format.

According to another embodiment of the present disclosure, an automated estimate quality assurance review method may comprise receiving, at a processor and via a communication network, a submitted estimate comprising a plurality of line items and corresponding to a loss type; storing the submitted estimate in a computer-readable memory; verifying that the submitted estimate qualifies for automated quality assurance review; analyzing the submitted estimate with the processor, wherein the analyzing comprises making a determination, based on the submitted estimate and at least one piece of information not included in the submitted estimate, as to whether the submitted estimate satisfies a predetermined requirement; and completing, with the processor, at least one post-review action.

The verifying that the submitted estimate qualifies for automated quality assurance review may comprise at least one of determining, with the processor, whether an entity associated with the submitted estimate is authorized to submit an estimate to the processor; or determining, with the processor, whether a user associated with the submitted estimate is authorized to submit an estimate to the processor. The verifying that the submitted estimate qualifies for automated quality assurance review may also comprise at least one of determining, with the processor, whether a type of the submitted estimate is one of a predetermined set of approved estimate types; or determining, with the processor, whether the submitted estimate meets a predetermined minimum data threshold.

The making the determination may comprise calculating a probability corresponding to at least one line item of the plurality of line items. The analyzing the submitted estimate with the processor may further comprise identifying at least one line item of the plurality of line items that corresponds to at least one disallowed line item from among a predetermined plurality of disallowed line items. The analyzing the submitted estimate with the processor may also further comprise deriving a set of guidelines from the submitted estimate.

Further, the analyzing the submitted estimate with the processor may further comprise comparing the derived guidelines with a set of predetermined guidelines, and the analyzing may comprise determining a compliance rate based on the comparison. Further still, the analyzing the submitted estimate with the processor further comprising comparing at least a portion of the submitted estimate with at least a portion of a new estimate generated based on information from the submitted estimate and further based on a set of predetermined guidelines.

The completing, with the processor, at least one post-review action may comprise generating a report containing the determination. The completing, with the processor, at least one post-review action may comprise automatically dialing a telephone number associated with the submitted estimate.

A quality assurance review server according to yet another embodiment of the present disclosure comprises a processor; a network interface; and a computer-readable memory storing instructions for causing the processor to receive an estimate comprising a plurality of line items via the network interface, the estimate corresponding a loss type; store the estimate in the computer-readable memory; analyze the estimate to determine a quality of the estimate, and generate a report. The analyzing comprises determining, for each line item from among the plurality of line items, a probability of the line item being associated with the loss type; identifying line items from among the plurality of line items that are included on a list of disallowed line items; deriving a set of guidelines from the estimate; comparing the derived guidelines to a predetermined set of guidelines; generating a new estimate based on information from the estimate and the predetermined set of guidelines; and comparing the estimate to the new estimate. The report comprises the probability for each line item from among the plurality of line items; the identified line items; a first indication of results of the comparison of the derived guidelines to the predetermined set of guidelines; and a second indication of results of the comparison of the estimate to the new estimate.

The memory may further comprise instructions for causing the processor to send the report to another device via the network interface.

The terms “memory,” “computer-readable medium” and “computer-readable memory” are used interchangeably and, as used herein, refer to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X1 and X2) as well as a combination of elements selected from two or more classes (e.g., Y1 and Z.).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 provides a flow chart of a method according to one embodiment of the present disclosure;

FIG. 2 provides a flow chart of a method according to another embodiment of the present disclosure;

FIG. 3 depicts a block diagram of a system according to yet another embodiment of the present disclosure;

FIG. 4 depicts a block diagram of a quality assurance review server that may, in some embodiments, be used as an alternative to the quality assurance review server depicted in FIG. 3; and

FIG. 5 provides a flow chart of a method according to yet another embodiment of the present disclosure.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

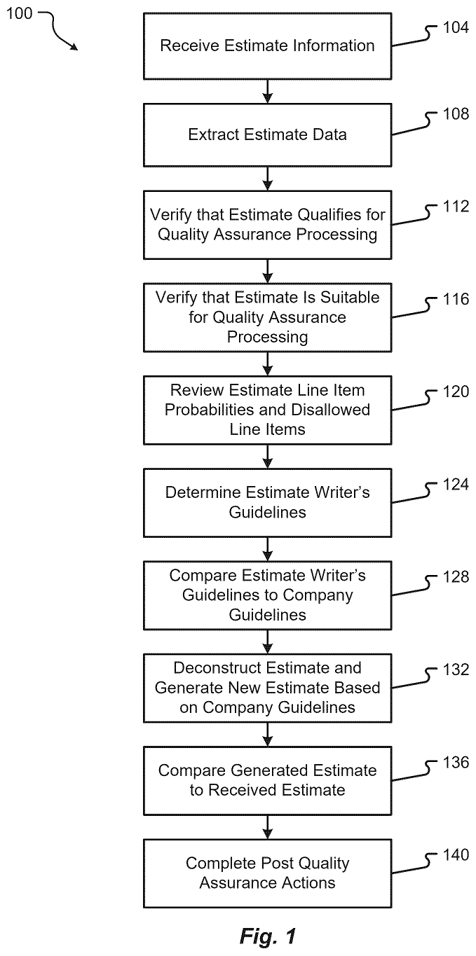

An automated quality assurance review process 100 according to embodiments of the present disclosure may include some or all of the steps identified in FIG. 1. For example, an automated quality assurance review process may include the step of receiving estimate information (step 104). The estimate information may be input manually into an automated quality assurance review system or may be provided directly from a computer-based estimating system. Subscribers to or other users of the automated quality assurance review system may choose to submit all estimates to the automated quality assurance review system (e.g., in batch), or to submit estimates to the automated quality assurance review system individually or on an as-needed basis. The automated quality assurance review system may accept estimate submissions via CRMs, email, or direct uploads, by way of example but not limitation. The automated quality assurance review system may include an importation module, wherein the module includes programming to convert one or more estimate file types into a file type used by the system.

Once an estimate is provided to the automated quality assurance review system, the system may review the received estimate and extract relevant data therefrom (step 108). Extracted data may include, without limitation, user data, loss data, property data, scope item data, and estimate amount data. If estimate information is provided in a format from which the automated quality assurance review system cannot extract data, and if the estimate information was not imported, converted, or otherwise changed to a usable format during the intake process, then the extracting step may require the additional step of converting the received estimate information from one format to another. Additionally or alternatively, optical character recognition or other automated data extraction processes may be utilized to prepare received estimate information for extraction and to accomplish the extraction of information from the received estimate information.

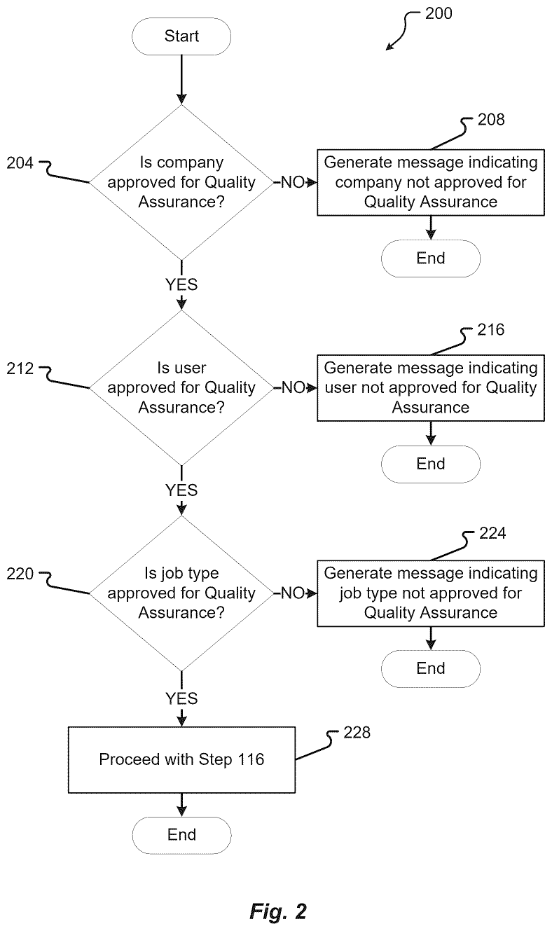

In some embodiments, the automated quality assurance review process 100 may include the step of determining whether the received estimate qualifies for review by the automated quality assurance review system (step 112). This step may itself comprise one or more steps, such as those set forth in the method 200 depicted in FIG. 2, which will now be described. For example, the system may check subscription records to ensure that the company or entity responsible for the estimate (e.g. an inspection company or an insurance company) is an active subscriber or client of the administrator of the automated quality assurance system (step 204). Such subscription records may be stored, for example, in a database, and the automated quality assurance system may submit the entity name or other entity information in a query to the database. Information stored in the database about the entity (to the extent such information exists) may be returned to the automated quality assurance system in response to the query. This process may all occur automatically, without any human involvement.

In some embodiments, subscription records may be kept in a subscriber database that simply contains information about which subscribers have subscribed to an automated quality assurance review system. In other embodiments, however, the subscriber database may contain much more detailed information. For example, in some embodiments, a subscriber may select specific aspects of an automated quality assurance review system to be included in the subscriber's subscription. In other words, the subscriber may subscribe at a level that provides access to the full functionality of the automated quality assurance review system, or the subscriber may subscribe at a level that provides partial access to the functionality of the automated quality assurance review system. A subscriber may, in some embodiments, subscribe to the automated quality assurance review system only with respect to particular catastrophe codes (which may correspond one or more of a hail storm, a wind storm, a flood, and a fire, for example). A subscriber may limit his, her, or its subscription to data extracted or otherwise available from estimates submitted over a limited date range (such that the subscriber does not benefit from the full range of analytics generated by the automated quality assurance review system). A subscriber may also limit his, her, or its subscription to specific policies, rules, or guidelines, such that the automated quality assurance review system does not conduct as detailed of a review of each estimate associated with the subscriber as is possible. These varying subscription levels may beneficially allow a subscriber to subscribe only to those features that will be of most benefit to the subscriber, or to obtain a subscription at a price that is acceptable to the subscriber.

If no subscription records are found for the company or entity in question, or if subscription records are found but indicate that the company or entity in question does not have a current subscription, then the system may generate a message indicating that the company or entity is not approved to use the automated quality assurance review system (step 208). The message may comprise text that is displayed on a screen associated with, for example, a computing device of the automated quality assurance review system (e.g. as an error message, a warning message, or an informational message), or that is transmitted via email, text message, regular mail (e.g. via a postal service), or other media. The message may additionally or alternatively comprise a visual indication, such as a flashing light, a stop sign, or the like, and/or an audio indication, such as a sound played through one or more speakers in operable communication with a computing device of the automated quality assurance review system. Once the message is transmitted or otherwise communicated, the automated quality assurance review process stops.

If, on the other hand, subscription records are found for the company or entity in question, and if the subscription records indicate that the company or entity has a current subscription, then the automated quality assurance review system may check individual user records to determine whether the user submitting the estimate is approved to access the automated quality assurance review system (step 212). As with the entity verification process described above, the system may check approved user records to ensure that the individual user submitting the estimate is authorized to access the automated quality assurance review system. The user records may be contained within the company or entity subscription records referenced above, such as, for example, if each company or entity designated one or more users authorized to participate in transactions involving the automated quality assurance review process on their behalf. Alternatively, the user records may be stored separately from the company or entity subscription records, particularly when, for example, users establish their own accounts with the automated quality assurance review process.

In some embodiments, information about which users are approved to access the automated quality assurance review system may be stored in a database, and the automated quality assurance review system may submit one or more pieces of user identification information (e.g. user name, user identification number, etc.) to the database in a query. The submitted information may be input, for example, by the user. The database may then respond to the query by returning information stored in the database corresponding to the identified user (to the extent such information exists). If the database responds with information indicating that the user is authorized or approved to use the automated quality assurance review system, then the system may proceed to determine whether the job type of the submitted estimate is approved for use with the automated quality assurance review system (step 220). Alternatively, if the database responds to the query with an indication that it has no information about the user, or if the information returned by the database indicates that the user is not or is no longer authorized to use the automated quality assurance review system, then the system may generate a message indicating that the user is not approved or authorized to use the system (step 216). The message may comprise text that is displayed on a screen associated with a computing device of the automated quality assurance review system (e.g. as an error message, a warning message, or an informational message), or that is transmitted via email, text message, regular mail (e.g. via a postal service), or other media. The message may additionally or alternatively comprise a visual indication, such as a flashing light, a stop sign, or the like, and/or an audio indication, such as a sound played through one or more speakers in operable communication with a computing device of the automated quality assurance review system. Once the message is transmitted or otherwise communicated, the automated quality assurance review process terminates.

In some embodiments, verification that the user is approved to access the automated quality assurance review system may be accomplished by requiring the user to log in to the system, e.g. by entering a username and password, or submitting an alternative credential. If the credentials are correct, then the user may be given access to the automated quality assurance review system. Such access may be limited (e.g. limited to certain features of the automated quality assurance review system) based on, for example, a subscription level of the user or of the user's company, or preferences determined by an administrator from the user's company (e.g. each user may be authorized only to submit estimates from the user's own department to the automated quality assurance review system). In one embodiment, access depends from the subscription selection of the individual and/or company accessing the automated quality review system.

Once the company and/or user of the automated quality review system has been verified as approved, the automated quality assurance review system may determine whether the job types of the estimate is a type that the automated quality assurance review system can handle, and/or whether the job type is included in the submitting entity's subscription package (in other words, whether the submitting entity has arranged with the owner or administrator of the automated quality assurance review system to submit estimates of the job type in question to the automated quality assurance review system) (step 220). If the job type is not one that the automated quality assurance review system can handle, or is not included in the submitting entity's subscription package, then the system may generate a message indicating that the user is not approved or authorized to use the system (step 224). The message may comprise text that is displayed on a screen associated with a computing device of the automated quality assurance review system (e.g. as an error message, a warning message, or an informational message), or that is transmitted via email, text message, regular mail (e.g. via a postal service), or other media. The message may additionally or alternatively comprise a visual indication, such as a flashing light, a stop sign, or the like, and/or an audio indication, such as a sound played through one or more speakers in operable communication with a computing device of the automated quality assurance review system. Once the message is transmitted or otherwise communicated, the automated quality assurance review process terminates.

If the automated quality assurance review system determines that the job type is one that the system can handle, and/or is included in the submitting entity's subscription package, then the system proceeds to determine whether an automated quality assurance review can be performed on a given estimate (step 228). Referring once again to FIG. 1, the next step is to verify the estimate is suitable for processing (step 116). This step may include checking the data of the received estimate to see if a minimum data threshold has been met. Minimum data thresholds may be set by the administrator of the automated quality assurance review system, and/or by subscribing entities or other customers. For example, subscribing entities or customers may determine that a certain minimum level of data must be provided to the automated quality assurance review system in order for use of the system to be cost-effective and/or sufficiently worthwhile. Alternatively, minimum data thresholds may be inherent in the system itself, such that the system is only capable of performing an automated quality assurance review if the minimum amount of data is provided to the system. A minimum data threshold may be defined as a minimum number of line items, as a minimum dollar value of the initial estimate, or as a minimum number of populated data fields, by way of example. Additionally, the minimum data threshold may vary depending on the job type, or provided data, by way of example. Thus, if certain types or pieces of data are provided, then the minimum data threshold may require that one or more corresponding types or pieces of data are also provided.

According to certain embodiments of the present disclosure, another step in an automated quality assurance review process involves reviewing estimate line item probabilities and disallowed line items (step 120). As noted above, estimating systems may have tens of thousands of line items that can be added to an estimate. Some estimating systems may automatically add (or may suggest the addition of) certain line items to an estimate based on the loss type for which the estimate is being prepared. For example, if the loss type is a hail damage loss, it is common for the estimate to include a plastic turtle roof vent line item. However, a plastic turtle roof vent line item is not common in an estimate for a theft loss. Similarly, some estimating systems may automatically add (or may suggest the addition of) certain line items to the estimate in groups, due to certain attributes of the real property at issue or based on the present of other line items in the estimate. Thus, for example, it is common to have paint siding and aluminum siding line items together in an estimate, but it is not common to have a paint siding and vinyl siding line item together in the same estimate. In this step, then, each line item is reviewed and assigned a probability score of being in an estimate for the specific loss type that is assigned to the line item. Groups of line items are also reviewed (e.g. each line item is compared against one or more other line items in the estimate), and the probability of the line items being in an estimate together is also assigned. The automated quality assurance review system can analyze the line item probabilities individually, as a whole, or in various combinations. Once such probabilities are determined, the automated quality assurance review system may flag line items that are associated with a probability that is below a predetermined threshold probability. Additionally, in some embodiments, the automated quality assurance review system may make a pass/fail determination based in whole or in part on whether any, or a minimum number of, the line items in the estimate are associated with a probability that is below a predetermined probability threshold. The pass/fail determination may also be based on any of the other determinations or analyses of the estimate as described herein, and may be included in a report generated after completion of the automated quality assurance review process for the estimate in question.

In some embodiments, a client or subscriber of the automated quality assurance review system may disallow certain line items or groups of line items, perhaps based on the presence in the estimate of one or more other line items. During the step of reviewing estimate line item probabilities and disallowed line items, the automated quality assurance review system may identify and flag disallowed line items included in an estimate. An overall estimate line item probabilities score can be assigned to the estimate, as well as a disallowed factor. This information may be displayed or otherwise provided to the submitting user, and/or to the company or other entity responsible for submitting the estimate, and/or to the company or other entity responsible for preparing the estimate, and/or to the company or other entity receiving the estimate. Alternatively, the probabilities score and/or disallowed factor may be used by the computational machinery to process the automated quality assurance review, and, by way of example but not limitation, provide a scoring or ranking for either further automated or, in some instances, manual quality assurance review processes.

Also in some embodiments, a client or subscriber of the automated quality assurance review system may require certain line items or groups of line items, whether for a given catastrophe code, based on the presence in the estimate of one or more other line items, or for another reason. In such embodiments, during the step of reviewing estimate line item probabilities and included line items, the automated quality assurance review system may identify and flag line items (or other information) that is required to be in the estimate but is not. This information may also be displayed or otherwise provided to the submitting user, and/or to the company or other entity responsible for submitting the estimate, and/or to the company or other entity responsible for preparing the estimate, and/or to the company or other entity receiving the estimate. Alternatively, information corresponding to the missing but required line items may be used to provide a scoring or ranking for either further automated or, in some instances, manual quality assurance review processes.

As another step in the automated quality assurance review process, the automated quality assurance review system may process the estimate through a guideline engine (such as the Accurence™ SettleAssist™ guideline engine) to derive the guidelines used by the estimate writer (step 124) to create, for example, the scope items, quantities, and depreciation associated with the estimate. One or more aspects of the Accurence™ SettleAssist™ guideline engine are described in U.S. Provisional Patent Application No. 62/251,536, filed on Nov. 5, 2015, and in U.S. patent application Ser. No. 15/345,071, filed on Nov. 7, 2016, both of which are incorporated herein by reference in their entirety. The estimate writer's guidelines could be based on company guidelines, the writer's interpretation of company guidelines, the writer's opinion, the contractor's opinion, information provided to the writer or contractor by coworkers or supervisors, or other criteria. The Accurence™ SettleAssist™ guideline engine, as one example of such an engine, is a pattern-matching engine, and can be run in reverse: in addition to applying certain guidelines to provided data to calculate an estimate, it can determine which guidelines were applied to provided data to obtain the results set forth in an estimate. Thus, for example, the guideline engine can compare depreciated values provided in the estimate with original values (which may be, for example, provided in the estimate, obtained from a value store database, entered manually, or the like), and determine the depreciation rate applied by the estimate writer. The guidelines applied by the estimate writer, as determined by the guideline engine, may be displayed or otherwise provided to the submitting user, and/or to the company or other entity responsible for submitting the estimate, and/or to the company or other entity responsible for preparing the estimate, and/or to the company or other entity receiving the estimate.

In some embodiments, a guideline engine may be configured such that certain line items and/or their attributes trigger events. These events may include, by way of example but not limitation, displaying or otherwise providing the guidelines applied by the estimate writer as described above; notifying the estimate writer to contact his or her supervisor prior to completing the claim settlement; notifying a quality assurance department or quality assurance personnel that additional review of the submitted estimate is needed; notifying the training department (e.g. to report problematic areas or issues that could be addressed with additional training); providing information regarding the applied guidelines (or regarding trends in applied guidelines) to a management dashboard; and/or providing information regarding the applied guidelines to a machine learning engine. As one example, if an applied guideline determined by the guideline engine is known to have an average cost greater than an alternative guideline, then detection of the applied guideline may trigger one or more emails, alerts, and/or other types of notifications highlighting the applied guideline and/or indicating that the applied guideline has a cheaper alternative guideline. For example, if the guideline engine determines that an estimate writer chose to replace a vent on a roof instead of detaching and resetting the vent, and if the guideline engine has determined that vent replacement costs, on average, $10 more than vent repair, then such information may be included in the one or more emails, alerts, and/or other types of notifications.

Also as part of determining the estimate writer's applied guidelines, a cost of the estimate writer's applied guidelines (whether individually or as a whole) may be calculated, estimated, or otherwise determined. The cost (or information regarding or derived from the cost) may trigger one or more events, including any of the events described above, and may also be included in a notification or otherwise utilized in a triggered event.

Once the applied guidelines are determined by the guideline engine, the applied guidelines can be compared to a predetermined set of guidelines, which may be, for example, the subscriber's guidelines, the client's guidelines, or standard industry guidelines (e.g. if the subscriber or client does not have its own set of guidelines), to determine whether all relevant guidelines were properly applied (step 128). The applied guidelines may additionally or alternatively be compared to guidelines applied by a coworker of the estimate writer, or to guidelines previously applied by the estimate writer in preparing a previous estimate. A compliance rate or other indicia of the extent of compliance by the estimate writer with the relevant guidelines can be calculated. This information too may be displayed or otherwise provided to the submitting user, and/or to the company or other entity responsible for submitting the estimate, and/or to the company or other entity responsible for preparing the estimate, and/or to the company or other entity receiving the estimate. The compliance rate may be based on number of guidelines complied with, or may be determined as a percentage deviation based on a guideline-by-guideline comparison of applied guidelines versus the subscriber's or client's guidelines. For example, if a particular client or subscriber guideline requires application of a depreciation rate of X, and the applied guideline utilized a depreciation rate of Y, then the percentage difference between X and Y may be calculated and reported as, or as part of, the compliance rate.

An automated quality assurance review process according to embodiments of the present disclosure may also include inputting the estimate line item attributes (e.g., data provided by the estimate writer in response to a line item in the submitted estimate) into the guideline engine (e.g., Accurence™ SettleAssist™ or any other guideline engine that contains the relevant guidelines for a given estimate), which may then use the estimate line item attributes to populate any necessary inspection forms and to generate an automated estimate (step 132). This may require deconstructing the original estimate to extract line items and/or line item attributes (e.g., to the extent they were not already extracted during the extracting estimate data step 108). The deconstructing may include both analyzing each line item of the estimate to identify a corresponding line item in the inspection forms to be used for generating the automated estimate, as well as identifying the data entered for each line item in the submitted estimate, which may then be used to populate the inspection forms needed to generate an automated estimate. In certain embodiments, estimates may be submitted using forms having line items that have already been mapped to a stored listing or database of standardized and/or customized line items, such that data from a submitted form can be quickly or even instantaneously matched with known line items. Further, the line items in the stored listing or database may already be mapped as well to inspection forms needed to generate an automated estimate, such that the automated quality assurance review system can populate such inspection forms with the correct data by utilizing existing correlations between the line items of the forms used by the submitted estimate and the stored listing or database of line items, and correlations between the stored listing or database of line items and the line items of the inspection forms. In other embodiments, line items from submitted estimate forms may be automatically or manually mapped to line items in a stored listing or database of line items, which may already be mapped to line items of inspection forms needed to generate an automated estimate. Such embodiments may be particularly useful when the automated quality assurance review system allows submission of estimates on non-standard forms, and/or to enable submission of estimates on non-standard forms.

Once an automated estimate has been generated, the automated estimate can be compared to the provided estimate, and differences therebetween can be flagged for display to, or for review by, the submitting user, and/or to the company or other entity responsible for submitting the estimate, and/or to the company or other entity responsible for preparing the estimate (step 136). In certain embodiments, the automated quality assurance review system may be programmed to ignore certain differences between the provided and automated estimates, such as those differences that are determined to be insignificant. By way of example, differences in dollar amounts that are less than five percent (5%) of the dollar amount, or differences in depreciation rates or labor rates that are less than a predetermined percentage, may be disregarded by the automated quality assurance review system.

Embodiments of an automated quality assurance review process as disclosed herein may include one or more post-quality assurance review actions (step 140). Such actions may include, for example, the preparation of a quality assurance report that includes some or all of the results of one or more of the steps described herein. Thus, for example, a quality assurance report may include, without limitation, one or more of an overall estimate line item probabilities score for the reviewed estimate, a disallowed factor for the reviewed estimate, a list of the disallowed line items included in the reviewed estimate, a compliance rate with applicable guidelines, a list of applicable guidelines, a list of applied guidelines that are different than or materially different than applicable guidelines, a calculated estimate, and a list of calculated estimate values that are different than or that are materially different than provided estimate values, among others.

Additionally, in some embodiments, an estimate's line item score, line item group score, overall score, disallowed items, estimate writer's guidelines, comparison to company guidelines results, automated reprocessing exceptions, or the like may trigger extending the quality assurance workflow, which may also fall within the scope of step 140. For example, the estimate may be flagged for further review. The automated quality assurance review system may generate an email requesting additional information from the estimate writer, or launch a live video review between the estimate writer and an offsite reviewer or expert, or generate a negative estimate writer scoring. The results of the automated quality assurance review process may also trigger a shortened quality assurance workflow, including approval for payment, a positive estimate writer scoring, and so forth.

Once an estimate is approved, a contractor may be hired to conduct the repairs identified in the estimate. Occasionally, such a contractor may discover additional damage that was not previously noticed (and perhaps not previously noticeable). This additional damage may be described in a supplemental estimate, which may estimate the cost of repairing the additional damage. A quality assurance review process such as that described above may be conducted for such supplemental estimates.

As persons of ordinary skill in the art will appreciate in light of the foregoing disclosure, the ability of an automated quality assurance review process to conduct a quality assurance review in real time or in near real time (e.g. within a period of 10 minutes or less, or 5 minutes or less, or 3 minutes or less, or 1 minute or less from submission of an estimate for quality review) means that the automated quality assurance system and/or an offsite reviewer or expert can request additional information from a person writing the estimate (the inspector or otherwise), or discuss with the estimate writer whether additional information is needed while the estimate writer is still onsite at the property at issue, or while the details of the estimate are still fresh in the estimate writer's mind. This further enhances efficiency and streamlines the estimate writing process.

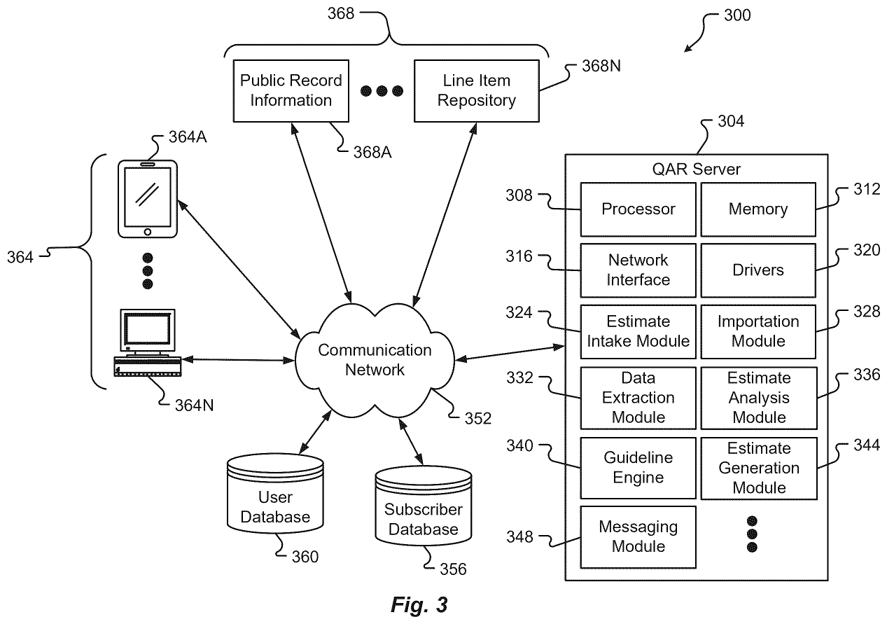

Turning now to FIG. 3, an automated quality assurance review system 300 according to embodiments of the present disclosure may include a quality assurance review (QAR) server 304. The QAR server 304 may include one or more hardware and/or software components, including a processor 308, a memory 312, a network interface 316, drivers 320, an estimate intake module 324, an importation module 328, a data extraction module 332, an estimate analysis module 336, a guideline engine 340, an estimate generation module 344, and a messaging module 348. These components are further described below, and through the operation of some or all of these components, the QAR server 304 may accomplish automated quality review as described herein.

The QAR server 304 may also include other hardware and/or software components not depicted in FIG. 3, including, without limitation, a power module, a graphical user interface, one or more user input devices (e.g. a keyboard, microphone, camera, etc.), one or more media output devices (e.g. a speaker, a video display, etc.), and one or more access control devices (e.g. a password protection module, a biometric scanner, a voice recognition module, etc.), among other components known to those of ordinary skill in the art. The various components of the QAR server 304 may be physically located in close proximity (e.g. within the same rack or cabinet), or they may not be in close physical proximity, yet may instead be operably connected through one or more wired and/or wireless connections. Additionally, although the QAR server 304 is depicted in FIG. 3 as a server, in other embodiments it may be any computing device, including, for example, a desktop computer, a laptop computer, a tablet, a smart phone, or an equivalent device.

A processor 308, as used in certain embodiments of the present disclosure, may correspond to one or many microprocessors that are contained within a common housing, circuit board, or blade with the memory 312. The processor 308 may be a multipurpose, programmable device that accepts digital data as input, processes the digital data according to instructions stored in its internal memory, and provides results as output. The processor 308 may implement sequential digital logic as it has internal memory. As with most microprocessors, the processor 308 may operate on numbers and symbols represented in the binary numeral system. The processor 308 may be or include, without limitation, any one or more of a Qualcomm® Snapdragon® 800 and 801, Qualcomm® Snapdragon® 610 and 615 with 4G LTE Integration and 64-bit computing, Apple® A7, A8, or A9 processor with 64-bit architecture, Apple® M7,M8, M9, or M10 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i 7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture. The processor 308 executes instructions stored in the memory 312 to initiate, maintain, and terminate collaborative sessions of the type described herein.

A memory 312, as used in certain embodiments of the present disclosure, may correspond to any type of non-transitory computer-readable storage medium. In some embodiments, the memory 312 may comprise volatile or non-volatile memory and a controller for the same. Non-limiting examples of a memory 312 that may be utilized in a computing device 304 include a portable computer diskette, a hard disk, a random access memory (RAM) (including any variety of random access memory, such as dynamic RAM (DRAM) and static RAM (SRAM)), a read-only memory (ROM), an erasable programmable read-only memory (EPROM or EEPROM or Flash memory), an optical fiber, a portable compact disc read-only memory (CD-ROM), an optical storage device, a magnetic storage device, or any suitable equivalent to or combination of the foregoing. The memory 312 stores instructions for execution by the processor 308, including drivers 320 and software and/or other instructions associated with network interface 316, estimate intake module 324, importation module 328, data extraction module 332, estimate analysis module 336, guideline engine 340, estimate generation module 344, and messaging module 348.

The network interface 316 may comprise hardware and/or software that facilitates communications with other communication devices over a communication network 352. The network interface 316 may include an Ethernet port, a Wi-Fi card, a Network Interface Card (NIC), a cellular interface (e.g., antenna, filters, and associated circuitry), or an equivalent device. The network interface 316 may be configured to facilitate a connection between the QAR server 304 and the communication network 352 and may further be configured to encode and decode communications (e.g., packets) according to a protocol utilized by the communication network 352. At various times throughout the estimate quality assurance review process, according to certain embodiments of the present disclosure, network interface 316 may be utilized to receive or send, for example, information corresponding to an estimate submitted for quality assurance review, information needed to properly complete a quality assurance review of an estimate, and information related to a completed quality assurance review.

The driver(s) 320 referenced in relation to FIG. 3 may correspond to hardware, software, and/or controllers that provide specific instructions to hardware components of the QAR server 304, thereby facilitating their operation. For instance, the network interface 316, memory 312, and/or other components of QAR server 304 (whether depicted in FIG. 3 or not) may each have a dedicated driver 320 that provides appropriate control signals to affect its/their operation. The driver(s) 320 may also comprise the software or logic circuits that ensure the various hardware components are controlled appropriately and in accordance with desired protocols. For instance, the driver 320 of the network interface 316 may be adapted to ensure that the network interface 316 follows the appropriate network communication protocols (e.g., TCP/IP (at one or more layers in the OSI model), TCP, UDP, RTP, GSM, LTE, Wi-Fi, etc.) such that the network interface 316 can exchange communications via the communication network 352. As will be appreciated by persons of ordinary skill in the art, the driver(s) 320 may also be configured to control wired hardware components (e.g., a USB driver, an Ethernet driver, fiber optic communications, etc.).

In some embodiments, an estimate intake module 324 is included, which controls the estimate submission process whereby estimates are submitted to the QAR server 304 for quality assurance review. The estimate intake module 324 may enforce a predetermined policy about acceptable file types of estimates submitted to the automated quality assurance review process. For example, the estimate intake module 324 may accept for submission only estimates that are submitted in a .docx format, or a .xlsx format, or a .pdf format, or another suitable format, whether proprietary or not. Upon receipt of an estimate, estimate intake module 324 may store the estimate in the memory 312, where it is then available to other modules or components of QAR server 304.

The estimate intake module 324 may incorporate a handshake, token pass or other authentication function to ensure that a device from which an estimate is submitted for quality assurance review is authentic. The estimate intake module 324 may also include an access control function, e.g. to verify that the company or entity on behalf of which the estimate is submitted is a current subscriber, to verify that the user submitting the estimate on behalf of the company or entity is an authorized user, to determine that the submitted estimate is a type of estimate that may be subjected to an automated quality assurance review (whether based, for example, or whether the estimate type is included in a subscription associated with the submitting company or entity and/or user, or on whether the estimate type is one for which the QAR server is capable of conducting a quality assurance review). In carrying out this access control function, the estimate intake module 324 may initiate or otherwise engage in communications with the subscriber database 356 and/or the user database 360, which store information about subscribers to the automated quality assurance review system and authorized users of the automated quality assurance review system, respectively. Although depicted separately from the QAR server 304 in FIG. 3, subscriber database 356 and user database 360 may be included as part of the QAR server 304, or may be operably connected directly to the QAR server 304 (e.g. without reliance on a communication network 352) as well. Thus, for example, the estimate intake module 324 may obtain information about the company or entity on behalf of which an estimate is submitted, and compare that information with information stored in the subscriber database 356 to determine whether the submitting company/entity is a subscriber. In embodiments, the estimate intake module 324 hosts a customer-facing graphical user interface that may be viewed, for example, on a monitor or other display operably connected to the QAR server 304, or in a web browser of a computing device 364, through which a user can submit estimates for automated quality assurance review. The customer-facing graphical user interface may also allow users to submit information corresponding to the estimate (e.g. the name of the company or entity on behalf of which the estimate is being submitted), and/or information used by the access control function.

The estimate intake module 324 may also analyze whether a submitted estimate meets a minimum threshold for included data to determine whether the estimate is sufficiently complete to be reviewed by the automated quality assurance review system. Alternatively, such an analysis may be conducted by a different module, such as estimate analysis module 336. In embodiments, some or all submitted estimates are analyzed for compliance with minimum data threshold requirements after being processed by a data extraction module 332, which processing is described below.

The importation module 328 may contain one or more file conversion functions to convert submitted estimates from one or more file types into one or more predetermined file types suitable for the automated quality assurance review process. Use of an importation module 328 may enhance the convenience of an automated quality assurance review system by allowing users to submit estimates using file types other than those that are suitable for the automated quality assurance review system. If, for example, the automated quality assurance review process is configured to process Portable Document Format (.pdf) files, then the importation module 328 may include instructions for causing the process to generate .pdf format files from files originally formatted as .doc/.docx files, .xls/.xlsx files, .ppt/.pptx files, .txt files, and .jpeg files, among other format types. In some embodiments, the automated quality assurance review system is programmed to use a proprietary file format, and the importation module 328 is configured to convert one or more common file types, such as those listed above, into the proprietary file format.

The data extraction module 332 processes received estimates and extracts data therefrom for use by one or more of, for example, the estimate analysis module 336, the guideline engine 340, the estimate generation module 344, and the messaging module 348. The data extraction module 332 may be programmed, for example, to apply one or more optical character recognition processes to a submitted estimate. The data extraction module 332 may also be programmed to identify and distinguish individual line items in an estimate as well as information provided in the estimate in response to each line item. In some embodiments, the data extraction module 332 may match line items extracted from a submitted estimate with known line items, which may be stored in the memory 312 and/or may be obtained from an external data source 368 such as the line item repository 368N.

The estimate analysis module 336 may, according to some embodiments of the present disclosure, review estimate line item probabilities and disallowed line items, e.g. to calculate a probability score of each line item being in an estimate of the type of the submitted estimate. Such calculations may utilize, for example, information obtained from an external data source 368 that correlates estimate types with specific line items, and allows, e.g., a determination of the number of times a given line item has been included in an estimate of a particular type. The estimate analysis module 336 may also calculate or otherwise determine, again using historical estimate data, a probability of a given line item from the submitted estimate being in an estimate that also includes one or more other given line items from the submitted estimate. In other words, the estimate analysis module 336 may compare each line item in a submitted estimate against one or more other line items in the estimate, and determine a probability of each line item being in the estimate in light of the other line items in the estimate. Line item probabilities may be determined and/or analyzed individually, as a whole, or in various combinations. In some embodiments, the estimate analysis module 336 may also identify line items that have a high probability of being included in estimates that include the line items of the estimate being reviewed, but that are not present in the estimate being reviewed.

Additionally, the estimate analysis module 336 may analyze a submitted estimate to determine whether the estimate contains line items that have been disallowed, whether by the owner or operator of the automated quality assurance review system, the company or other entity on behalf of which the estimate was submitted, or some other interested party. The module 336 may flag disallowed line items for reporting to the user or another entity by a messaging module 348.

Still further, the estimate analysis module 336 may perform text recognition on handwritten notes to identify missing information or to identify information that corroborates one or more aspects of the estimate. Similarly, the estimate analysis module 336 may analyze pictures or video submitted with the estimate to identify supporting or corroborating evidence. Systems and methods useful for performing video or still image analysis on building structures are described in U.S. patent application Ser. No. 15/445,509, the entirety of which is hereby incorporated herein by reference.

As an example, the estimate analysis module 336 may be configured to recognize in a photograph evidence of hail damage on a roof or on a roof vent. The estimate analysis module 336 may further be configured to calculate, from a photograph and using some indication of scale (whether provided in the photograph, or submitted separately from the photograph) one or more dimensions from which information in the estimate can be corroborated, updated, or identified as inaccurate or likely inaccurate. The estimate analysis module 336 may in some embodiments access satellite photographs (such as might be available, for example, via Google Maps, or from a commercial satellite imagery provider) to obtain such information. For example, satellite imagery may be useful for determining or estimating the square footage of a roof, or even for estimating the square footage of a home. The estimate analysis module 336 may compare recent photographs or satellite imagery with historical photographs or satellite imagery to determine whether certain damage was the result of a catastrophic event or predated the catastrophic event. In some embodiments, the estimate analysis module 336 may be configured to extract scale information and other relevant data from metadata associated with one or more electronic image files.

Aside from gathering evidence in support of damage-related information in an estimate, the estimate analysis module 336 may also gather repair-related information. For example, the estimate analysis module 336 may be configured to reference labor statistics to determine the average length of time needed to complete a particular repair task, or to look up the applicable tax rate(s) in a given jurisdiction, or to evaluate an applicable insurance policy for coverage information, or to look up the applicable insurer's policies for a needed repair, or to look up the amount of profit a given insurer will allow to a contractor or other service provider. The estimate analysis module may be configured to analyze photographs or even a 3-dimensional model of a room to calculate or otherwise determine the square footage of the walls, so as to calculate the amount of paint needed to repaint the walls, or the amount of carpet needed to replace the flooring, or the amount of drywall needed to repair flood damage. Still further, the estimate analysis module 336 may access analytics generated by a reporting module 452 (described in greater detail below) or other QAR server component to identify, for example, which line items are most commonly included in estimates for the loss type in question, so as to determine whether the estimate being analyzed includes all such line items.

In some embodiments, an estimate analysis module 336 may also have access to information about supplemental estimates, which reflect changes made to an approved estimate while repairs are actually taking place. Supplemental estimates are useful for evaluating the actual cost of repairs, as well as which repairs are actually needed in connection with a given loss type, because they are typically prepared and submitted once the full extent of the damage is known. (Often, the full extent of damage caused by a particular catastrophe is not readily apparent to an estimate writer in the first instance, as the damage may be hidden behind walls or under carpet, or otherwise shielded from view, such that it is discovered only when repair work actually commences.) In some embodiments, the QAR server 304 or 404, or the quality assurance review system 300, may be configured to analyze original estimates and corresponding supplemental estimates so as to identify relevant patterns and trends. For example, the analysis may determine that the presence of particular line items in a given estimate frequently corresponds to the existence of a supplemental estimate with one or more additional line items. Such a determination may indicate that a particular type of damage, or damage to a particular component or structure, is indicative of an additional type of damage, or of additional damage to the same or a different structure, that is not usually identified at the time of the original estimate. Such functionality may beneficially be utilized by the estimate analysis module 336 during quality assurance reviews of original estimates to identify or flag estimates that are likely to be supplemented at a later date, and to either request that the estimate writer check for the additional damage likely to exist or to provide an indication to the estimate writer and/or the insurance carrier or other subscriber that the cost of the estimate is likely to increase over time due to the nature of the damage described by the estimate. The estimate analysis module 336 may estimate or predict whether one or more additional line items will need to be added to the analyzed estimate, or whether the amount of a given estimate is within the range of estimates for similar situations, or the like.

The estimate analysis module 336 may also be configured to apply conditional logic when analyzing estimates. For example, the estimate analysis module 336 may be configured to disallow a particular line item if a given combination of other line items is present in the estimate, or to require a given line item based on what other line items are in the estimate.

As part of the automated quality assurance review process, a submitted estimate may be analyzed by a guideline engine 340. As described above, a guideline engine such as the guideline engine 340 may, for example, derive the guidelines used by the estimate writer to create scope items, quantities, and depreciation. The guideline engine can then compare the derived guidelines applied by the estimate writer with the applicable guidelines for the submitted estimate (which may be determined, for example, by the company or entity on behalf of which the estimate was submitted, the owner or operator of the automated quality assurance review system (e.g. an insurance company that must make a decision about how to proceed based on the submitted estimate), or another party) to determine whether the estimate writer properly applied the applicable guidelines when preparing the submitted estimate.

In some embodiments, the guidelines applied to a given estimate (or the level of required compliance with those guidelines) may vary based on the level of trust between the insurance carrier (which establishes the guidelines) and the estimate writer. For example, if an estimate writer is new to working with the insurance carrier in question, then the guidelines applied to the estimates submitted by the estimate writer may be particularly strict, without allowances for exceptions or deviations from the guidelines. Once the estimate writer has achieved a degree of trust with the insurance carrier, the requirements imposed on the estimate writer with respect to the guidelines may be relaxed somewhat, so as to allow the estimate writer some leeway in complying with the guidelines, or so as to apply less strict guidelines. Multiple levels of trust may be defined, and multiple levels of guidelines may be applied. In some embodiments, the insurance carrier or other subscriber determines (and can periodically adjust) the degree of trust and/or the applicable guidelines). In other embodiments, the degree of trust may be adjusted automatically as predetermined thresholds are met. In some embodiments, the price charged to the subscriber of applying stricter guidelines may be greater than the cost of applying guidelines that are not as strict.

Also in some embodiments, an insurance carrier may have the ability to (or may configure the quality assurance review system to automatically) loosen the guidelines applicable to estimates arising out of a particular catastrophe. Such estimates may be identified by a unique catastrophe code that corresponds to the catastrophe in question, or by a data range combined with a loss type (if, for example, the catastrophe in question was the only one of its kind to occur on a particular day or within a particular date range). The purpose of this “loosening” or lowering of applicable standards may be to respond to a temporarily heightened number of estimates. Where the normally applied standards or guidelines may require estimates to be revised or manually approved due to a relatively insignificant deviation from proper procedures and protocols, loosening of the standards or guidelines may allow estimates with relatively minor deficiencies to be approved notwithstanding such deficiencies, thus reducing the number of estimates that need to be manually reviewed or corrected and allowing the applicable insurance carrier(s) to process a higher number of estimates than would otherwise be possible.

The loosening or lowering of applicable standards may comprise ignoring slight deviations from all guidelines, or it may comprise changing the set of guidelines against which a given estimate is reviewed. For example, an insurance carrier may wish to apply only a subset of guidelines in quality assurance reviews of estimates related to a particular catastrophe, which guidelines may relate, for example, to the most critical items or most expensive items on the estimate. As another example, an insurance carrier that usually permits a deviation from applicable guidelines of only five percent (5%) may allow a deviation from applicable guidelines of ten to fifteen percent (10-15%) for estimates arising out of a particular catastrophe.

The estimate generation module 344 utilizes data extracted from a submitted estimate (e.g. by the data extraction module 332) and applicable guidelines (e.g. from guideline engine 340) to generate a new, automated estimate. The estimate generation module 344 may obtain needed information (e.g. information about current labor rates, depreciation rates, etc.) from a public record information external data source 368A. The extracted data used by the estimate generation module 344 may include one or both of line items and line item attributes, e.g. information provided by the estimate writer in response to each line item. Once a new estimate has been generated, the estimate generation module 344 may then compare the automatically generated estimate with the submitted estimate, and may flag for reporting line items in the submitted estimate that are not identical to, or that are not within a predetermined tolerance of, line items in the automated estimate.

A messaging module 348 may be included in a QAR server 304 to generate and transmit reports of the automated quality assurance review process to interested parties, which may include, for example, the user/estimate writer, the company or entity on behalf of which the estimate was submitted to the QAR server 304, the owner and/or operator of the QAR server 304, and one or more entities identified as an interested party during the estimate submission process. The reporting may include information about items that were flagged during the automated quality assurance review process, including information about the reason the item was flagged. The reporting may also include information about the probabilities of a given line item being included in an estimate of the type of the submitted estimate, and/or of a given line item being included in an estimate in light of one or more other line items in an estimate. The reporting may include, as well, results of the comparison of the submitted estimate with the automatically generated estimate.

Reports generated by the messaging module 348 may be viewable by a user of a computing device 364 using a web browser, or by a user of the QAR server 304 using a display operably connected to the QAR server 304. Alternatively, reports generated by the messaging module 348 may be provided in an email or similar electronic message, for transmission to one or more interested parties via the communication network 352. In some embodiments, the messaging module 348 may be operably connected to a telephone, cell phone, smart phone or equivalent, and may be configured to establish a voice connection via the telephone, cell phone, smart phone or equivalent with the estimate writer based on the results of the automated quality assurance review process, or at any point during the automated quality assurance review process (e.g. if additional information is needed and/or if the automated quality assurance review process identified one or more errors or discrepancies that might be resolved by obtaining more information from the estimate writer). In such embodiments, the messaging module 348 may include an automated interactive voice response system so that only the estimate writer's involvement is needed for the call. Alternatively, the messaging module 348 may establish the voice connection between the estimate writer on the one hand and quality assurance personnel (e.g. persons associated with the owner/operator of the QAR server 304) on the other, and the quality assurance personnel may be responsible for speaking with the estimate writer and inputting information obtained therefrom into the QAR server 304 for use by one or more modules thereof.

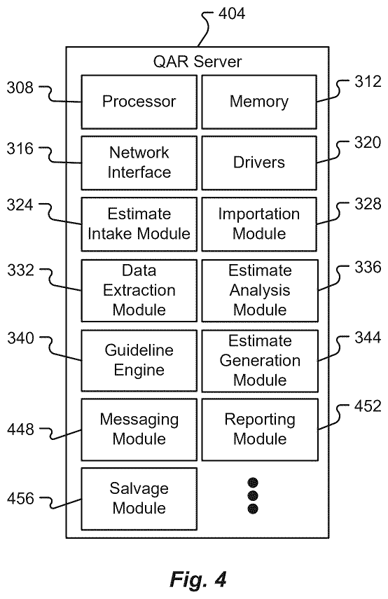

Turning now to FIG. 4, according to another embodiment of the present disclosure a QAR server 404 may be used instead of the QAR server 304 in a quality assurance review system such as the quality assurance review system 300. The QAR server 404 may include many of the same components as the QAR server 304, including a processor 308, a memory 312, a network interface 316, drivers 320, an estimate intake module 324, an importation module 328, a data extraction module 332, an estimate analysis module 336, a guideline engine 340, and an estimate generation module 344. Each of these components may operate in the same or in a substantially similar way as described above with respect to the QAR server 304. The QAR server 404 may further comprise a messaging module 448, a reporting module 452 and a salvage module 456. These components are further described below. Through the operation of some or all of the components of the QAR server 404, the QAR server 404 may accomplish automated quality review as described herein.

As with the QAR server 304, the QAR server 404 may also include other hardware and/or software components not depicted in FIG. 4, including, without limitation, a power module, a graphical user interface, one or more user input devices (e.g. a keyboard, microphone, camera, etc.), one or more media output devices (e.g. a speaker, a video display, etc.), and one or more access control devices (e.g. a password protection module, a biometric scanner, a voice recognition module, etc.), among other components known to those of ordinary skill in the art. The various components of the QAR server 404 may be physically located in close proximity (e.g. within the same rack or cabinet), or they may not be in close physical proximity, yet may instead be operably connected through one or more wired and/or wireless connections. Additionally, although the QAR server 404 is depicted in FIG. 4 as a server, in other embodiments it may be any computing device, including, for example, a desktop computer, a laptop computer, a tablet, a smart phone, or an equivalent device.

The messaging module 448 has at least the same functionality (including both internally and in its interactions with other components) as the messaging module 348. The messaging module 448 may be responsible for generating or establishing communications from or between the QAR server 404 and a resource external to the QAR server 404. Such communications may be used, for example, for gathering additional information about an estimate, requesting or otherwise obtaining estimate guidelines, notifying the submitter of an estimate (whether the specific individual who submitted the estimate, or an employer or other company with which the individual is associated) of one or more errors in the estimate, or of the results of the quality assurance review, or for requesting or otherwise obtaining supporting evidence for one or more pieces of information in an estimate.

The messaging module 448 may be equipped to transmit or establish communications via one or more of several protocols. In some embodiments, the messaging module 448 may be equipped to automatically place a telephone call to the submitter of an estimate, to a representative of the employer or other company with which the submitter of the estimate is associated, to an insurance company associated with the estimate, to a public information resource (e.g. a source of historical weather information), or to a commercial enterprise from which pricing information is needed (whether pricing information regarding material pricing, salvage pricing, labor pricing, or otherwise). The messaging module 448 may further be equipped to transfer the call, once placed, to a human operator, or to utilize an interactive voice response (IVR) or other automated system to provide information or results, request and/or obtain needed information, or otherwise accomplish the purpose of the call. Where the messaging module 448 transfers the call to a human operator, the messaging module 448 may further be configured to transmit information regarding the purpose of the call to a display or other device accessible to the human operator, so that the human operator can accomplish the purpose of the call. In some embodiments, the messaging module 448 may utilize an automated system to provide verbal information to the human operator (e.g. over the phone) about the purpose of the call before connecting the human operator to the contacted person or other entity.

The messaging module 448 is not limited to telephone communications. Rather, the messaging module 448 may be utilize email, text messaging, fax, or any other communication medium to accomplish its purposes. The messaging module 448 may generate messages and store them in a subscriber's QAR system inbox, which the subscriber may access at his or her leisure. The messaging module 448 may also cause a message or report to be printed for mailing to a target recipient. Additionally, the messaging module 448 may interact with other components of the QAR server 404, so that all external communications functions are centralized in the messaging module 448. For example, the messaging module 448 may be used for communications related to estimate intake that are handled by the estimate intake module 324, including communications with the subscriber database 356 and the user database 360 to verify that a submitter is a subscriber and/or authorized user of the quality assurance review system. As another example, the messaging module 448 may be utilized in connection with one or more of the events described above in connection with the operation of a guidelines engine, including, for example, notifying the estimate writer to contact his or her supervisor prior to completing the claim settlement.

The messaging module 448, in some embodiments, is configured to track responses to messages transmitted by the messaging module 448. For example, if the messaging module 448 sends a request for additional information to an estimate writer, the messaging module 448 may track whether the estimate writer responds with the additional information and, if so, how much time passed between the sending of the request and the receipt of the response and whether the additional information provided was sufficient. The messaging module 448 may further be configured to send periodic reminders regarding messages to which the messaging module 448 has not received a response. Then, the messaging module 448 or another component of the QAR server 404 may be configured to track such information as how many messages must be sent to a given estimate writer before the estimate writer responds; what is the average response time of the estimate writer; and whether the estimate writer “learns from” the messages sent, by including the information requested by one or more messages for one submitted estimate in subsequent submitted estimates of a similar type. This information may be used to grade the estimate writer, and such grades may be used by an insurance carrier or other subscriber to assess the performance of each estimate writer. The messaging module 448 may also track which types of messages are responded to and which are not, and this information may be used by the QAR server 404 to determine the effectiveness of different message types. Message types with low effectiveness may then be changed or discontinued-whether automatically by the system or at the direction of a system administrator-as appropriate.

The reporting module 452 generates and provides various reports to users of the QAR server 404. The information used by the reporting module 452 to generate such reports may be stored in a computer-readable memory of the QAR server 404, or it may be stored in computer-readable storage accessible to the QAR server 404 via the communication network 352. Regardless of its physical location, the computer-readable memory may comprise a data warehouse that receives information from one or more of the various components of the QAR server 404 (e.g. the data extraction module 332, the guideline engine 340, the estimate analysis module 336, the estimate generation module 344), and/or from one or more components external to the QAR server 404 (e.g. the subscriber database 356 and the user database 360), via Extract, Transform, Load (ETL) processes. Such processes are well known in the art.

In operation, the reporting module 452 conducts and provides access to analytics on the data available to the QAR server 404 or to the QAR system 300 as a whole. Thus, the reporting module 452 may provide one or more dashboards from which a user may view such information as the average difference between estimates submitted to the QAR server 404 and estimates generated by the estimate generation module 344; the average estimate amount for estimates of a similar loss type, or for a particular loss type in connection with a specific catastrophic event; summaries of information about all estimates processed to date, or about a specific subset of estimates processed to date (e.g. all estimates submitted by a particular user, or all estimates submitted within a particular date range, or all estimates corresponding to an identified loss type, or all estimates involving a particular structure or component); the average number of prohibited line items in a given estimate; and the most commonly included prohibited line items in estimates for a given loss type. The reporting module 452 may be configured to conduct roll-up operations so as to obtain and/or display relevant or requested data at a higher, summary level of detail, as well as drill-down operations, so as to obtain and/or display relevant or requested data at a more specific, increased level of detail.

Still further, the reporting module 452 may be configured to provide alerting services to a subscriber to the QAR system 300 or other user of the QAR system 300 or QAR server 404. The reporting module 452 may interact with the messaging module 448 to communicate alerts to the intended recipient. Alerting services provided by the reporting module 452 may include alerting a subscriber or other user when a given estimate exceeds a threshold number of prohibited or unauthorized line items, or exceeds a certain cost threshold, or relates to a specific loss type, or is submitted by a particular estimate writer, or contains conflicting information (e.g. too much paint required given the square footage of the area to be painted, or too many singles required given the square footage of the roof). Provided alerting services may further include alerting a subscriber or other user when an average number of errors in a defined category of estimates surpasses a given threshold, or when the average cost of the estimates exceeds a certain cost threshold.

The QAR server 404 further comprises a salvage module 456. The salvage module 456 comprises (or at least has access to, perhaps via a communication network 352) a database storing salvage data. The salvage data includes, for at least one geographic area, information about the salvage yards located in the geographic area and information about the prices that can be obtained for various materials at those salvage yards. The information about the salvage yards may include, for example, an address, a telephone number or email address, hours of operation, and whether the salvage yard is a preferred salvage yard for one or more insurance carriers. The information about the prices may include, for example, a price per unit weight for one or more metals or other materials that can be obtained by selling such materials to the salvage yard. The price information may also include information about the price that can be obtained by selling certain components (e.g. used or broken air conditioners, furnaces, or household appliances). The database may also store information about the quantity of certain materials in a plurality of appliances, systems, devices, or other objects that are commonly removed from a damaged site. For example, the database may comprise one or more lookup tables containing identification information about a plurality of air conditioners, as well as information about how much aluminum, steel, copper, and/or any other salvageable material is contained within the air conditioner.

The salvage module 456 is configured to process estimates to identify, based on the information in the estimate about damages suffered and needed repairs, components and materials that can be salvaged. In some embodiments, the salvage module 456 further determines which salvage yard within a predetermined proximity to the affected site will offer the highest price for the salvageable material, and provides both the address and/or contact information of the salvage yard in question as well as an estimate of the total dollar amount that may be recovered by selling the materials and components identified as salvageable to the salvage yard.

For example, if a home suffers flood damage that destroys the home's air conditioner and furnace, so as to require replacement of the same, an estimate may include a line item for removal of the old air conditioner and furnace and another for installing a new air conditioner and furnace. When the salvage module 456 reviews the estimate, the salvage module 456 may determine, from the information in the estimate, that an air conditioner and a furnace will be removed from the home. Where the estimate includes the brand and model number, or other identification information, for the air conditioner and furnace in question (or where such information can be obtained, perhaps by sending a message to the estimate writer), the salvage module 456 may search the database of salvage data for the weights of salvageable materials contained in that specific air conditioner and that specific furnace. The salvage module 456 may also search the database for salvage yards within a predetermined proximity (e.g. 5 miles, or 10 miles, or 30 miles, or 50 miles) to the home in question that would accept the air conditioner and furnace, and compare the prices offered at each of those salvage yards so as to identify which salvage yard will pay the most for the air conditioner and furnace. In this way, the salvage module 456 reduces the need for an estimate writer or contractor to identify nearby salvage yards, contact those salvage yards to determine prices, estimate the total amount of salvageable material that will result from the needed repairs, and determine which salvage yard will pay the most for the material in question. The salvage module 456 takes care of these details, allowing a contractor or other worker to simply take the salvageable material directly to the identified salvage yard. Given that salvage operations are rarely conducted due to the inconvenience and opportunity cost associated with them, the salvage module 456 beneficially removes much of that inconvenience and opportunity cost and helps to make salvage operations practical, which in turn beneficially reduces the amount of waste sent to a landfill and lowers the overall cost of a given project.

The salvage module 456 may, in some embodiments, perform only a subset of the features and functions described above. The salvage module 456 may also be configured to build or supplement its database by receiving information from contractors about the actual prices paid by a given salvage yard for a given piece of material or for a given component. In such embodiments, the received information may be used to update prices offered by the salvage yard for a given material, and also to update information about how much salvageable material is contained within a given item or component.

Also in some embodiments, the database utilized by the salvage module 456 may be maintained by a third-party company. In such embodiments, the owner or manager of the QAR server 404 or of the quality assurance review system 300 may gain access to the database of salvage-related information by subscription or otherwise. Also in some embodiments, a given insurance carrier may negotiate preferred pricing with a given salvage yard or a plurality of salvage yards, and the salvage-related database may contain information about such preferred pricing, so that the preferred pricing is taken into account when the salvage module 456 compares available pricing for an estimate corresponding to the insurance carrier that negotiated the preferred pricing. Alternatively, the salvage module 456 may be configured to always select a particular salvage yard for estimates associated with an insurance carrier that has negotiated preferred pricing or another deal with the salvage yard, or for any other reason.

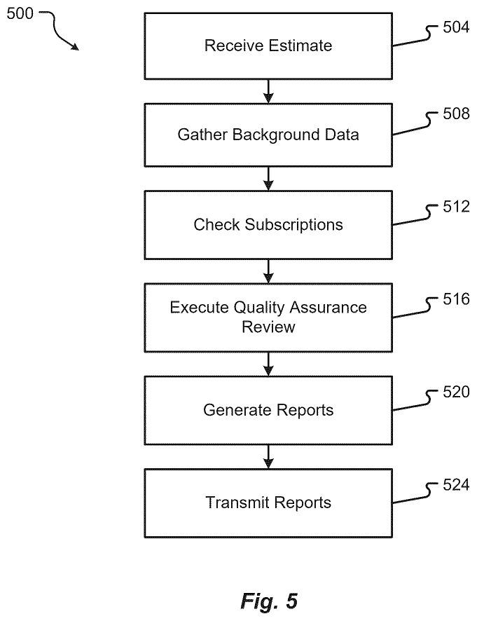

Turning now to FIG. 5, a method 500 according to embodiments of the present disclosure begins when an estimate is received by a quality assurance review system (step 504). The estimate may be received via a web-based submission application, or it may be emailed, or it may be scanned from a physical document, stored electronically, and loaded into the quality assurance review system. Receiving the estimate may in some embodiments comprise running an optical character recognition function on the estimate, so as to convert image data into text data that can be analyzed by the quality assurance review system. Receiving the estimate may comprise one or more of the features or functions described above with respect to step 104 of the method 100 and/or with respect to the estimate intake module 324 of the QAR server 304 of the quality assurance review system 300.

The quality assurance review system conducts a preliminary review of the received estimate and gathers relevant background data (step 508). For example, the quality assurance review system may locate, within the estimate, an address of a property that is the subject of the estimate. This address may be used to assemble, collect, load, or otherwise gather such information as the jurisdiction within which the property is located, the sales tax for that jurisdiction, the relevant laws in that jurisdiction (regarding, for example, building codes and insurance claims), and the average price of relevant services in that jurisdiction (which may be available on a per-project basis (e.g. average cost of replacing a furnace), or on an hourly basis (e.g. the average hourly rate of a carpet installer in the jurisdiction in question), or both). The preliminary review may also be used to identify the insurance carrier associated with the estimate and to load or otherwise gather the relevant guidelines for that insurance carrier, and to determine whether there are any preferred or preapproved contractors associated with the identified insurance carrier. In some embodiments, the step 508 includes one or more of the features or functions described above in connection with step 108 of the method 100 and/or in connection with the importation module 328 and/or data extraction module 332 of the QAR server 304 of the system 300.

Additionally, the quality assurance review system checks a subscription database to verify the existence of the needed subscription(s) as well as the scope of the subscription(s) (step 512). For example, insurance providers may subscribe to the quality assurance review system so that estimates submitted to the insurance provider are quality reviewed. The insurance provider, however, may only provide certain kinds of insurance, and that insurance may cover only certain types of claims. As a result, the insurance provider may subscribe to a subset of the services offered by the quality assurance review system. Even within a given claim type, a subscriber may in some embodiments choose specific aspects of an estimate to review. In some embodiments, for example, a subscriber may want to obtain the information such as that provided by the salvage module 356, and therefore may obtain a subscription that includes review of submitted estimates by a salvage module. Another subscriber may not need or desire the information provided by the salvage module, however, and therefore may select a subscription that does not include review of estimates by a salvage module. As another example, a module such as the estimate analysis module 336 may provide a plurality of features or services, and a subscriber may subscribe to all of those features or services, or to a subset of those features or services.

Checking the subscription database may also comprise verifying that the estimate writer is an authorized user of the quality assurance review system. In some embodiments, the quality assurance review system may accept estimates for submission only from estimate writers who have been identified by one of the insurance providers that has subscribed to the system. In other embodiments, estimate writers may be authorized simply by setting up an account with the quality assurance review system, although in such embodiments the estimate writer may still only be permitted to submit estimates that are associated with an insurance provider that has subscribed to the quality assurance review system. In still other embodiments, estimate writers may be required to subscribe to the quality assurance review system in the same manner or in a similar manner as insurance providers. Step 512 may comprise one or more features or functions described above with respect to steps 112 and 116 of the method 100, and/or with respect to the estimate intake module 324 of the QAR server 304 of the system 300.

Also in the method 500, the quality assurance review system executes the quality assurance review according to the subscription(s) of the associated insurance provider and/or estimate writers (step 516). The quality assurance review may include any of the aspects described herein, without regard to whether those aspects are described in connection with the methods 100 or 200, the system 300 (whether including the QAR server 304 or the QAR server 404), or are not described in connection with any particular embodiment.

Whether during or after execution of the quality assurance review (or both during and after), the quality assurance review system generates one or more reports (step 520). The reports, which may be generated, for example, by a reporting module 452, may be standard reports, which are populated with the same types of information regardless of the entity for whom they are generated, and/or custom reports, which may include types of information selected by an entity associated with the estimate that has been reviewed (e.g. the insurance provider that will ultimately approve or deny the estimate, or the estimate writer). The report may contain information about, for example, the background data gathered during the method 500, the quality behaviors and derived facts obtained during the method 500, the subscriptions associated with the quality assurance review conducted in the method 500, the modules or features utilized or applied during the quality assurance review, and the results of the quality assurance review. The report may further identify additional information needed to bring the reviewed estimate within the applied guidelines. In some embodiments, the report may include information about the estimate writer's performance over time, including the number of estimates submitted by the estimate writer that have passed and/or failed the quality assurance review, the responsiveness of the estimate writer to requests for additional information, and the historical accuracy of the estimate writer's estimates (to the extent the quality assurance review system receives information about the final costs associated with estimates that have been approved).

Once the one or more reports have been generated in step 520, the quality assurance review system transmits the one or more reports (step 524). The one or more reports may be transmitted via email or facsimile, or may be uploaded to a web-accessible data storage location for later viewing by the entity for whom the report was generated. In some embodiments, such as where the report is simply a request for more information, the report may be provided verbally (e.g. over a telephone connection) by an interactive voice response system. Reports may also be provided via text message. The reports may be transmitted, for example, by a messaging module such as the messaging module 448.

Notably, a quality assurance review system according to embodiments of the present disclosure may be utilized to review the quality of estimates from a plurality of estimate writers, and thus may be configured to evaluate submitted estimates according to the policies of any one or more of a plurality of insurance providers. Moreover, such a system may review the quality of a given estimate writer's estimates for a plurality of different insurance providers. Because such a quality assurance review system is able to aggregate such a wide array of data, the system is able to accomplish tasks that simply cannot be accomplished in any other way. For example, the quality assurance review system can analyze all submitted estimates to identify patterns and trends that could not be identified with a smaller subset of estimates, particularly if that smaller subset of estimates were being manually reviewed by multiple people. In some embodiments, patterns and trends identified with respect to one category of estimates (whether estimates associated with a given catastrophe type, or with a given insurance carrier, or sharing another similarity) may be discerned and then applied to one or more other categories of estimates. Company-specific (or individual-specific) estimates may then be compared against such patterns and trends, allowing the identification of quality issues that would not be possible if the estimates of just that company or individual were analyzed for quality assurance purposes.

As another example, the overall quality of an estimate writer can be readily assessed (e.g. by compiling information about the results of one or more quality assurance reviews conducted on estimates submitted by the estimate writer) and reported to the insurance company or companies for whom the estimate writer prepares estimates, thus allowing the insurance company or companies to make educated decisions about the estimate writers with it (or they) work.

Still further, because a single QAR server 304 or 404, or a single QAR system 300, examines all submitted estimates—and can do so within seconds or minutes-ranking or other comparisons of the estimates can be accomplished, so as to triage estimates requiring the most immediate attention. For example, the QAR server 304 or 404 may identify, via message to an insurance provider, the top 5 or 10 or 20 or 50 or 100 most expensive estimates, or estimates having the worst quality, or estimates most likely to exceed the estimated cost, or estimates at risk of exceeding the estimated cost by the greatest amount, or estimates of the highest value that cannot move forward until additional data is submitted. Such comparisons simply would not be feasible if a handful of estimates were being reviewed by each of a dozens or hundreds of individuals, given the amount of communication and coordination that would be required as well the inability of ensuring that each individual conducts each quality assurance review in exactly the same way, applying exactly the same standards.

Relatedly, the use of a quality assurance review system 300 and/or a QAR server 304 or 404 to review the quality of submitted estimates allows for a much more extensive and detailed review of each estimate, as compared with the level of detail achievable with the manual reviews that are currently being conducted in the art. Insurance provider policy manuals contain far more information than any one person can assimilate, such that human reviewers must either focus on a small subset of policies that can readily memorized-thus sacrificing a detailed review of each estimate-or take the time to look up the policies applicable to each item in the estimate-which makes a review of every estimate impossible. Indeed, based on available statistics, insurance carriers are able to conduct a quality assurance review on less than 5% of submitted estimates. A quality assurance review system according to embodiments of the present disclosure can not only review 100% of submitted estimates, but can review each estimate in detail, compare each estimate to other estimates, identify patterns across hundreds or thousands of estimates that are not discernible by reviewing fewer estimates, and use those patterns to provide insurance carriers with information needed to improve quality, reduce wasteful expenditures, and improve certainty and predictability. Such a system can also apply different guidelines or policies as appropriate for a given insurance carrier and a given jurisdiction without taking any time to become familiar with the applicable guidelines or policies, which is not the case for a human reviewer.

Another advantage of the automated quality assurance review systems and methods disclosed herein is that a quality assurance review on a submitted estimate may be completed in a matter of seconds or minutes, such that feedback on the estimate may be provided to the estimate writer while the estimate writer is still on site at the damaged property. This allows the estimate writer to gather any additional information needed, and/or to make any necessary changes to the estimate, while the estimate is still fresh on his or mind and without having to return to the site at a later time and/or date. Under the current system, in which quality assurance reviews of estimates are conducted manually, significant time is wasted because estimate writers only receive feedback after leaving the site and, in many cases, after the details of the estimate in question have been forgotten. Once feedback is received, the estimate writer has to refresh his or her recollection and possibly even return to the site, resulting in an inefficient use of time and lost productivity.

The QAR server 304 or 404 may also be configured to utilize machine learning to improve its own quality assurance reviews. For example, the QAR server 304 or 404 may be configured to identify estimates that failed quality assurance review by the QAR server 304 or 404 but that were manually approved anyway, and to search such estimates for unique patterns or trends. When such patterns or trends are identified, the QAR server 304 or 404 may be configured to allow other estimates exhibiting the same unique patterns or trends to pass, even though they would otherwise fail. Further, the QAR server 304 or 404 may be configured to request and/or receive feedback on the results of its quality assurance reviews, and to use such feedback to adjust its conduct of quality assurance reviews. More specifically, the QAR server 304 or 404 may receive information from an insurance carrier about estimates that underwent quality assurance review and were subsequently approved by that insurance carrier, and may compare the estimates as approved by the insurance carrier to the results of the quality assurance review. Where the QAR server 304 or 404 identifies a pattern of the insurance carrier approving estimates notwithstanding a particular defect or issue identified during the quality assurance review, the QAR server 304 or 404 may enforce guideline or policy associated with the defect or issue less strictly. Alternatively, where the QAR server 304 or 404 identifies a pattern of the insurance carrier changing a particular item that was not identified as a defect, the QAR server 304 or 404 may be configured to commence evaluating that item during the quality assurance review, and identifying a defect whenever the value associated with the item does not match or otherwise correspond with the value associated with the item in the estimates finally approved by the insurance carrier.

The machine learning may be individual-or company-specific. Thus, if the QAR server 304 or 404 determines that a particular estimate writer's estimates are repeatedly approved by an insurance carrier even when they have certain defects, the QAR server 304 or 404 may be configured to stop identifying such defects on the estimates submitted by the estimate writer in question and for the insurance carrier in question.

As another example of machine learning, the QAR server 304 or 404 may be configured to compare estimates that present information in different orders, correlate each line item on one estimate with a line item on the other estimate, and the complete the comparison regardless of the differing orders. Such comparisons can be exploited to identify new patterns of relevance to the quality assurance review process, which patterns can then be included for subsequent quality assurance reviews.

Submitted estimates, as well as insurance carrier-specific guidelines and policies, may be or contain proprietary or confidential information. To enable the quality assurance review system to beneficially utilize all of the information available to it while protecting the proprietary or confidential nature of at least some of that information, the quality assurance review system according to embodiments of the present disclosure may be configured to anonymize the data it receives from individuals, companies, and other sources. Data anonymization may comprise one or more steps such as data encryption, data filtering, data obfuscation, data translation, and data commingling. By anonymizing data before analyzing the data for patterns and trends, the risk of disclosure of proprietary or confidential information can be reduced or eliminated, thus allowing the entire data set to be exploited for pattern identification purposes that can subsequently be used for the benefit of all subscribers.

In some embodiments, the system of the present disclosure comprises an analytics engine, and the methods of the present disclosure comprise an analytics step. The analytics engine and step may be useful for conducting any of the analytics described herein. In some embodiments, the analytics engine and step comprise portions of other modules, engines, or steps described herein. Regardless of whether the analytics engine and step stand alone or are incorporated into other modules/engines or steps, the analytics engine and step may be useful for determining quality characteristics or behaviors, and/or derived facts.

Quality characteristics or behaviors are configuration points in a system that drive the behavior of one or more modules or engines used in the system (e.g. the estimate analysis module 336 and/or the guideline engine 340) and are used to abstract the underlying behavior of the modules or engines based on company guidelines. For example, a quality behavior may be used to determine which of a plurality of branches in a decision tree or decision matrix should be selected by the applicable module or engine. In other words, the quality behavior aids in determining the path to be followed by the module or engine, and may be represented in programming language by a statement in a form such as “if(something) else do something else.” Derived facts are data points derived from data in a submitted estimate that provide abstract descriptions of the underlying data. The derived facts are accumulations of data in the estimate from which patterns or repeated situation types may be identified. A derived fact might profile property damage based on facts or observations in a submitted estimate such as “Contains Water Damage” or “Uses X #of trades”.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

As can be seen from the above description, the system and method disclosed herein are useful for automating the process of quality assurance review of property repair and other estimates. Specific details were given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Persons of ordinary skill in the art will also understand that various embodiments described above may be used in combination with each other without departing from the scope of the present disclosure.

1. A computer system comprising:
a processor;
a network interface; and
memory comprising instructions that, when executed, cause the processor to:
receive, via the network interface, an electronic repair estimate comprising a plurality of line items and corresponding to a loss type;
extract, from the electronic repair estimate, at least one line item and at least one attribute of the at least one line item;
derive, from data in the electronic repair estimate, a derived fact, wherein the derived fact includes an accumulation of data in the electronic repair estimate and identifies one or more patterns or repeated situation types in the data;
apply a machine learning model to determine a probability score for the at least one line item based on the at least one line item, the derived fact, and the loss type, wherein the probability score reflects a probability that the at least one line item corresponds to the loss type;
evaluate, with a guideline engine, compliance of the electronic repair estimate with predetermined guidelines based at least in part on the probability score, wherein the guideline engine uses one or more quality behaviors to select a branch in a decision matrix; and
generate and transmit via the network interface a quality assurance report identifying at least one of the probability score, a flagged line item, or a guideline deviation in response to receiving the electronic repair estimate.

2. The computer system of claim 1, wherein the one or more quality behaviors comprise one or more configuration points used by the guideline engine to select the branch in the decision matrix.

3. The computer system of claim 2, wherein the one or more configuration points drive behavior of the guideline engine based on the predetermined guidelines.

4. The computer system of claim 1, wherein the memory further comprises instructions that, when executed, cause the processor to identify a plurality of electronic repair estimates having failed a compliance evaluation and analyze the plurality of electronic repair estimates having failed the compliance evaluation to identify unique patterns.

5. The computer system of claim 1, wherein the memory further comprises instructions that, when executed, cause the processor to, in response to identifying a pattern of electronic repair estimates being approved despite non-compliance with one or more of the predetermined guidelines, reduce enforcement of the one or more predetermined guidelines associated with the pattern.

6. The computer system of claim 4, wherein the memory further comprises instructions that, when executed, cause the processor to allow other electronic repair estimates exhibiting the unique patterns to pass the compliance evaluation, even though the other electronic repair estimates would otherwise fail the compliance evaluation.

7. The computer system of claim 1, wherein the memory further comprises instructions that, when executed, cause the processor to, in response to identifying a pattern of an insurance carrier changing an item not identified as non-compliant, configure the guideline engine to evaluate the item in subsequently received electronic repair estimates and identify non-compliance whenever a value associated with the item does not match a value associated with the item in electronic repair estimates finally approved by the insurance carrier.

8. The computer system of claim 1, wherein the memory further comprises instructions that, when executed, cause the processor to modify guideline enforcement thresholds used by the guideline engine in response to a temporarily heightened number of electronic repair estimates being received.

9. The computer system of claim 8, wherein modifying the guideline enforcement thresholds comprises applying a subset of the predetermined guidelines in a compliance evaluation of a received electronic repair estimate.

10. The computer system of claim 8, wherein modifying the guideline enforcement thresholds comprises at least one of adjusting tolerance levels for deviations from one or more guidelines and changing a set of guidelines against which a an electronic repair estimate is evaluated.

11. The computer system of claim 1, wherein the memory further comprises instructions that, when executed, cause the processor to modify guideline enforcement thresholds used by the guideline engine in response to detecting one or more of a unique catastrophe code and a date range combined with the loss type.

12. The computer system of claim 1, wherein the memory further comprises instructions that, when executed, cause the processor to perform data anonymization on at least a portion of data in the electronic repair estimate, the data anonymization comprising one or more of data encryption, data filtering, data obfuscation, data translation, and data commingling.

13. The computer system of claim 12, wherein the memory further comprises instructions that, when executed, cause the processor to perform the data anonymization before analyzing anonymized data to identify one or more of patterns and trends.

14. The computer system of claim 1, wherein the probability score comprises a group probability score reflecting a probability that a group of line items corresponds to the loss type.

15. The computer system of claim 1, wherein the memory further comprises instructions that, when executed, cause the processor to transmit one or more inspection forms associated with the electronic repair estimate to a user device.

16. The computer system of claim 1, wherein the memory further comprises instructions that, when executed, cause the processor to populate one or more inspection forms associated with the electronic repair estimate with information retrieved from an external data source.

17. The computer system of claim 16, wherein the memory further comprises instructions that, when executed, cause the processor to compare at least a portion of the populated one or more inspection forms with at least a portion of the electronic repair estimate.

18. The computer system of claim 1, wherein the memory further comprises instructions that, when executed, cause the processor to populate one or more inspection forms with data by utilizing existing correlations between the plurality of line items of the electronic repair estimate and a database of line items.

19. A method comprising:
receiving, via a network interface, an electronic repair estimate comprising a plurality of line items and corresponding to a loss type;
extracting, from the electronic repair estimate, at least one line item and at least one attribute of the at least one line item;
deriving, from data in the electronic repair estimate, a derived fact, wherein the derived fact includes an accumulation of data in the electronic repair estimate and identifies one or more patterns or repeated situation types in the data;
applying a machine learning model to determine a probability score for the at least one line item based on the at least one line item, the derived fact, and the loss type, wherein the probability score reflects a probability that the at least one line item corresponds to the loss type;
evaluating, with a guideline engine, compliance of the electronic repair estimate with predetermined guidelines, based at least in part on the probability score, wherein the guideline engine uses one or more quality behaviors to select a branch in a decision matrix; and
generating and transmitting via the network interface a quality assurance report identifying at least one of the probability score, a flagged line item, or a guideline deviation in response to receiving the electronic repair estimate.

20. A server, comprising:
a processor; and
a computer-readable memory storing instructions for causing the processor to:
receive, via a network interface, an electronic repair estimate comprising a plurality of line items and corresponding to a loss type;
extract, from the electronic repair estimate, at least one line item and at least one attribute of the at least one line item;
derive, from data in the electronic repair estimate, a derived fact, wherein the derived fact includes an accumulation of data in the electronic repair estimate and identifies one or more patterns or repeated situation types in the data;
apply a machine learning model to determine a probability score for the at least one line item based on the at least one line item, the derived fact, and the loss type, wherein the probability score reflects a probability that the at least one line item corresponds to the loss type;
evaluate, with a guideline engine, compliance of the electronic repair estimate with predetermined guidelines, based at least in part on the probability score, wherein the guideline engine uses one or more quality behaviors to select a branch in a decision matrix; and
generate and transmit via the network interface a quality assurance report identifying at least one of the probability score, a flagged line item, or a guideline deviation in response to receiving the electronic repair estimate.
